(19) United States
(12) Patent Application Publication
(10) Pub. No.: US 2024/0419493 A1
(43) Pub. Date: Dec. 19, 2024

(54) System and Method for Token-based Graphics Processing Unit (GPU) Utilization

(71) Applicant: Microsoft Technology Licensing, LLC, Redmond, WA (US)

(72) Inventors: Sanjay Ramanujan, Sammamish, WA (US); Karthik Raman, Sammamish, WA (US); Rakesh Kelkar, Bellevue, WA (US); Kalyan Kumar Bhukya, Telangana (IN); Archit Shukla, Belgaum (IN); Pei-Hsuan Hsieh, Seattle, WA (US)

(21) Appl. No.: 18/334,723

(22) Filed: Jun. 14, 2023

(51) Int. Cl. G06F 9/50

(52) U.S. Cl. CPC G06F 9/5027

(57) ABSTRACT

A method, computer program product, and computing system for processing workload data associated with processing a plurality of requests for an artificial intelligence (AI) model on a processing unit. A maximum number of key-value (KV) cache blocks available for the workload data is determined by simulating the workload data using a simulation engine. A token utilization for the workload data is determined based upon, at least in part, the maximum number of KV cache blocks available for the workload data. Processing unit resources are allocated for the processing unit based upon, at least in part, the token utilization.

### BACKGROUND

Artificial intelligence (AI) models are becoming increasingly prevalent in technology and business environments. For example, AI models coupled with large language models (LLMs) are being used more than ever before. As such, the ability to provide resources to address these AI models and the processing required to respond to requests made to these AI models is generally limited by processing capability and availability.

### BRIEF DESCRIPTION OF THE DRAWINGS

FIG. 1 is a flow chart of one implementation of a utilization process;

FIG. 2 is a diagrammatic view of the utilization process of FIG. 1;

FIGS. 3-5 are diagrammatic views of the process for determining a maximum number of key-value (KV) cache blocks and a token utilization for workload data using a simulation engine according to various implementations of the utilization process of FIG. 1;

FIG. 6 is a diagrammatic view of the allocation of processing unit resources according to an implementation of the utilization process of FIG. 1; and

FIG. 7 is a diagrammatic view of computer system and a utilization process coupled to a distributed computing network.

Like reference symbols in the various drawings indicate like elements.

### DETAILED DESCRIPTION OF THE PREFERRED EMBODIMENTS

Implementations of the present disclosure allow for token-based allocation of processing unit resources for AI models based on token utilization. A token is a portion of a request submitted to an AI model for processing. For example, an individual token is a portion (e.g., about four characters of a word in the English language for one specific AI model) of an input to an AI model. When processing requests, a processing unit (e.g., GPU) resources are generally pre-allocated based on utilization constraints. One conventional approach to measuring GPU resource utilization includes a measurement of the percentage of time a GPU kernel is running for a particular sampling interval. However, compared to implementations of the present disclosure, this can be significantly inaccurate (e.g., up to thirty percent different). Another conventional approach to measuring GPU resource utilization includes measuring power consumption. However, this approach does not account for seasonality and troughs in request demand. As such, implementations of the present disclosure provide more accurate determination of GPU utilization by measuring utilization in terms of tokens processed by the AI model.

For example, implementations of the present disclosure determine the conditions in which a workload (e.g., pattern of requests) for an AI model operating on a GPU results in rejected or queued requests, thus degrading AI model performance. These conditions are determined in terms of a maximum number of key-value (KV) cache blocks available for the GPU by simulating the workload data using a simulation engine. As requests are processed by an AI model using a GPU, a KV cache is used to store key vectors and value vectors calculated for particular tokens in a request in distinct KV blocks. By caching these vectors in KV cache blocks, repetitive calculations that would reduce GPU efficiency are avoided. However, the KV cache has a limited capacity that is dependent upon the workload processed for the AI model. As such, the present disclosure simulates the workload to determine the maximum number of KV cache blocks available for the workload before the KV cache blocks are saturated and subsequent requests are rejected. With the maximum number of KV cache blocks, the present disclosure determines a number of tokens available for the workload and a number of processing tokens (i.e., tokens being used at a given point in time). Using the number of tokens available for the workload and the number of processing tokens, the token utilization is determined. In this manner, implementations of the present disclosure determine GPU utilization in terms of the number of tokens processed by the AI model and KV cache block saturation.

The details of one or more implementations are set forth in the accompanying drawings and the description below. Other features and advantages will become apparent from the description, the drawings, and the claims. The Utilization Process:

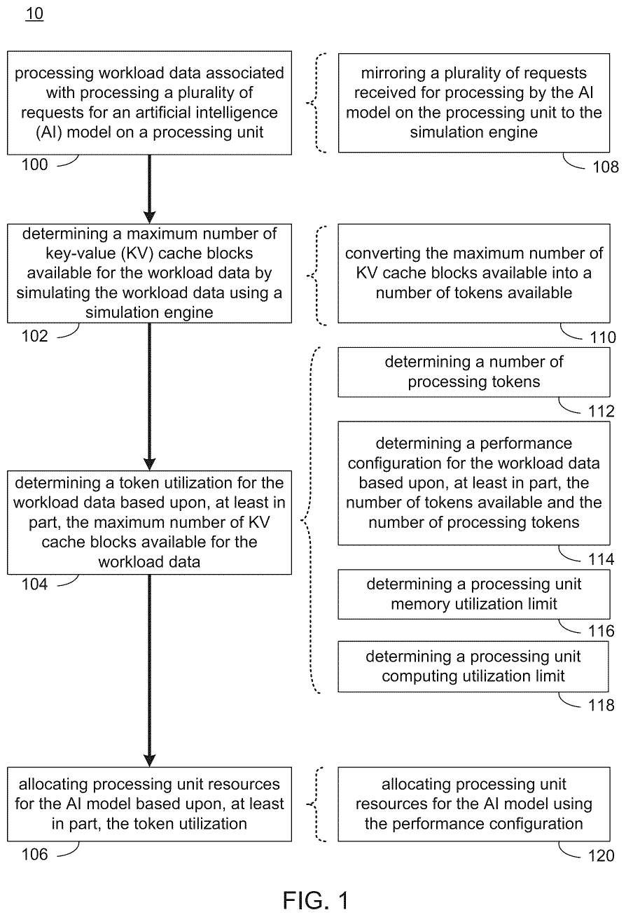

Referring to FIGS. 1-6, utilization process 10 processes 100 workload data associated with processing a plurality of requests for an artificial intelligence (AI) model on a processing unit. A maximum number of key-value (KV) cache blocks available for the workload data is determined 102 by simulating the workload data using a simulation engine. A token utilization for the workload data is determined 104 based upon, at least in part, the maximum number of KV cache blocks available for the workload data. Processing unit resources are allocated 106 for the workload data based upon, at least in part, the token utilization.

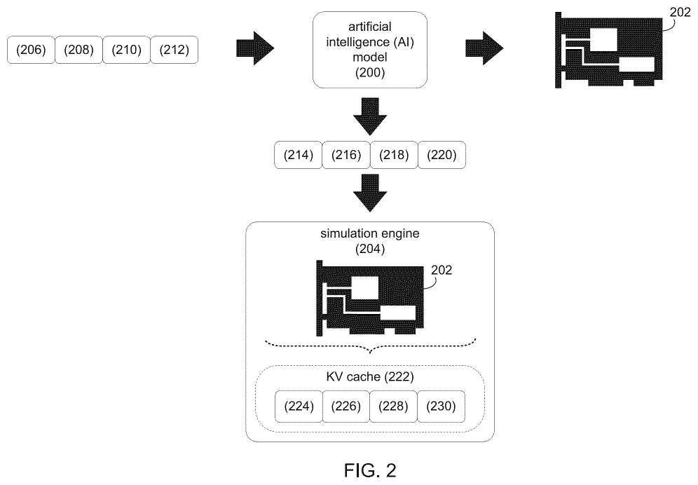

Referring also to FIG. 2 and in some implementations, utilization process 10 processes 100 workload data associated with processing a plurality of requests for an artificial intelligence (AI) model on a processing unit. Workload data associated with processing a plurality of requests for an AI model generally includes a collection of requests processed using an AI model. Workload data includes the requests processed using the AI model and any information concerning the requests (e.g., analytical data, metadata, etc.). An AI model uses neural networks to identify patterns and structures within a data set to perform a particular task (e.g., convert speech to text, generate new data (e.g., generative AI model), identify a biometric profile within a plurality of biometric profiles, solve complex mathematical problem, etc.). In some implementations, an AI model (e.g., AI model 200) is configured to receive natural language prompts and/or example entries and/or contextual information concerning a request to generate a response. In some implementations, the AI model includes a Large Language Model (LLM). A LLM (e.g., GPT-4 from OpenAI®, OpenLLaMa, and Cerebras-GPT) is a language model consisting of a neural network with many parameters (typically billions of weights or more), trained on large quantities of unlabeled and/or labeled text using self-supervised learning, semi-supervised learning, and/or fine-tuning of the weights to cater the neural network for particular tasks or workloads. Though trained on simple tasks along the lines of predicting the next word in a sentence, LLMs with sufficient training and parameter counts capture the syntax and semantics of human language. In addition, LLMs demonstrate considerable general knowledge and are able to “memorize” large quantities of facts during training and/or to generate new data that has the appearance of existing information.

In some implementations, the workload data associated with processing a plurality of requests describes “a shape” of the requests (i.e., the pattern and size of requests and responses in terms of request and response token sizes). For example, suppose an AI model is asked to “write an essay describing the benefits of drinking water”. In this example, the request is limited to a few tokens while the response includes many tokens (likely including several sentences). As such, the workload data for this request includes a small length request (e.g., measured in number of tokens) and a larger length request (e.g., measured in number of tokens). As will be discussed in greater detail below, processing this request using AI model 200 is likely to experience GPU memory limitations when being processed. By contrast, a request to generate a code segment that performs a number of particular functions is a larger request (e.g., measured in terms of tokens) while the response includes a small number of tokens relative to the request. In this example, processing this request using AI model 200 is likely to experience processing unit (e.g., central processing unit (CPU), graphics processing unit (GPU), etc.) computing limitations when being processed. Accordingly, the workload data associated with processing a plurality of requests defines the types of requests and the respective number of tokens of the requests and the expected responses.

In some implementations, a processing unit is used when processing a plurality of requests for an AI model. In one example, a central processing unit (CPU) is used when processing a plurality of requests for an AI model. In one example, a graphics processing unit (GPU) is used when processing a plurality of requests for an AI model. A GPU (e.g., GPU 202) is a specialized processing unit with enhanced mathematical computation capability using parallel processing, making it ideal for machine learning and artificial intelligence. In some implementations, a GPU can be grouped or clustered with other GPUs. As such, reference to a GPU includes any number of GPUs working individually or grouped together. When processing a plurality of requests, an AI model converts the request into a plurality of tokens. As discussed above, token is a processible portion of a request. For example, each AI model defines a number of tokens for a request and for the associated response. In some implementations, when processing a new request, the AI model divides the request into a plurality of tokens. In other implementations, the AI model processes an input stream by converting the input stream into a plurality of tokens. In one example, each token length is identical. In another example, each token length is unique and determined using various parameters, rules, and/or thresholds. As such, with distinct token lengths for various AI models, utilization process 10 processes 100 the workload data for a plurality of requests for the AI model to determine the utilization for each workload. As will be discussed in greater detail below, with the workload data, utilization process 10 is able to determine the token utilization for a respective AI model processing that workload data.

In some implementations, processing 100 the workload data includes mirroring 108 a plurality of requests received for processing by the AI model to the simulation engine. For example, as opposed to wasting requests on exclusively determining token utilization, utilization process 10 mirrors 108 or copies a plurality of requests received for processing by the AI model on the processing unit to a simulation engine. A simulation engine (e.g., simulation engine 204) is a software component configured to simulate the processing of tokens from a plurality of requests for an AI model on a processing unit. As will be discussed in greater detail below, simulation engine 204 models the processing unit performance when processing the plurality of tokens using various metrics (e.g., latency, requests per second (RPS), token processing rate, etc.). In some implementations, simulation engine 204 generates a plurality of simulations for different metrics and derives relationships between each metric to determine token utilization within the GPU for the workload associated with the plurality of requests.

Referring again to FIG. 2, mirroring 108 a plurality of requests (e.g., requests 206, 208, 210, 212) includes generating a copy of each request and providing the copied request to AI model 200 and simulation engine 204. In another example, mirroring 108 the plurality of requests includes generating a plurality of tokens (e.g., tokens 214, 216, 218, 220) from the plurality of requests using AI model 200 and copying the tokens (e.g., tokens 214, 216, 218, 220) to simulation engine 204. In this manner, utilization process 10 mirrors 108 the requests and/or the tokens generated from the requests to simulation engine 204.

In some implementations, utilization process 10 determines 102 a maximum number of key-value (KV) cache blocks available for the workload data by simulating the workload data using a simulation engine. As discussed above, a key-value (KV) cache block is a portion of memory used to store and quickly access results of a previous attention calculation for a particular request. For example, many AI models include transformer architecture models that are composed of attention blocks. An attention block is a portion of an AI model that allows the AI model to account for global context information within a request with particular emphasis on past tokens by focusing “attention” on more important tokens and lessening “attention” on less important tokens. This attention is represented as a weighting applied to the tokens. To calculate the attention at token index “i”, the transformer architecture determines the key vector or “k” and value vector or “v” from many of the tokens before index “i”. Accordingly, the key vector and the value vector at index “0” may be needed by every subsequent token. To avoid re-computation of these vectors when processing tokens in parallel, most inference implementations cache these key and value vectors in a KV cache (e.g., KV cache 222). In some implementations, KV cache 222 includes a plurality of allocated memory portions or cache blocks of a fixed size. In some implementations, the size of each KV cache block is dependent upon the GPU and/or the AI model. As will be described in greater detail below, the size of the KV cache limits the processing of individual requests. For example, when all of the KV cache blocks are fully utilized, no new requests can be processed until one or more KV cache blocks become available. For example, when the KV cache limit is reached (i.e., the maximum number of KV cache blocks), the GPU is fully saturated any the AI model will reject any new requests due to the overloaded state. Once the existing queue is sufficiently drained or cleared, new requests can be processed by the AI model. Accordingly and as will be discussed in greater detail below, utilization process 10 determines 102 the maximum number of KV cache blocks available for the workload based upon, at least in part, the number of KV cache blocks used before the KV cache limit is exceeded.

Referring again to FIG. 2 and in some implementations, utilization process 10 determines 102 a maximum number of KV cache blocks available for the workload data by simulating the workload data using a simulation engine. For example, simulation engine 204 simulates a processing unit (e.g., GPU 202) with a KV cache (e.g., KV cache 222). KV cache 222 is simulated with a number of KV cache blocks (e.g., KV cache blocks 224, 226, 228, 230). As described above, utilization process 10 uses the processed workload data associated with the plurality of requests (e.g., requests 206, 208, 210, 212) to simulate the performance of GPU 202. For example, using the workload data associated with requests 206, 208, 210, 212, utilization process 10 determines which simulations and/or parameters for particular simulations to run for the processed workload. In one example where the workload “shape” (i.e., the pattern and size of requests and responses in terms of request and response token sizes) is indicative of smaller requests and longer responses (i.e., “write an essay describing the benefits of drinking water”), utilization process 10 simulates the workload data for processing unit memory limitations. In another example where the workload “shape” is indicative of a longer request but a shorter response (i.e., a request to generate a code segment that performs a number of particular functions), utilization process 10 simulates the workload data for processing unit computing limitations.

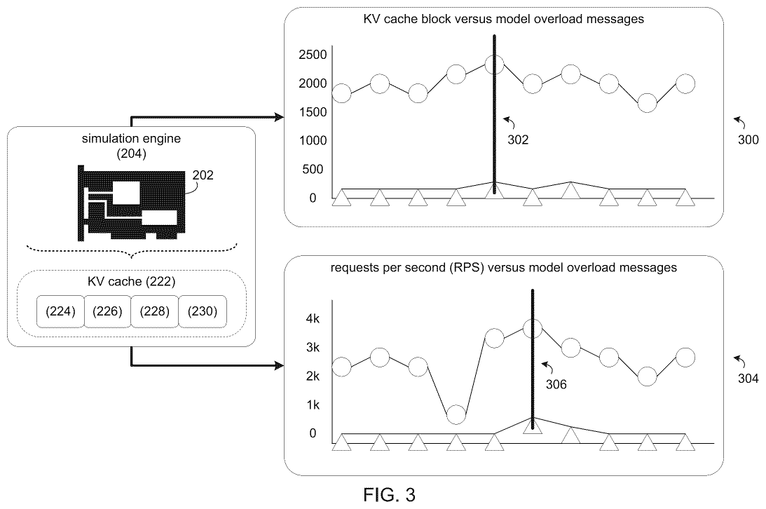

Referring also to FIG. 3, utilization process 10 determines a maximum number of KV cache blocks available for the workload data using simulation engine 204. For example, utilization process 10 simulates a number of KV cache blocks used versus a number of model overload messages as shown in graph 300 of FIG. 3. In graph 300, the circular points represent the number of KV cache blocks over time and the triangular points represent the number of model overload messages over time. In this example, utilization process 10 determines the point (e.g., point 302) where utilization process 10 receives a model overload message indicating that the KV cache capacity is saturated or is exceeded. Accordingly, utilization process 10 determines 102 the maximum number of KV cache blocks as the number of KV cache blocks in which model overload messages are first received indicating that the number of available KV cache blocks in KV cache 222 is exceeded.

In some implementations, determining 102 the maximum number of KV cache blocks available for the workload data includes converting 110 the maximum number of KV cache blocks available into a number of tokens available. For example, utilization process 10 uses the workload data to determine the size of each token processed by AI model 200. With the maximum number of KV cache blocks available as an amount of memory, utilization process 10 divides the total memory size of the maximum number of KV cache blocks by the token size to determine the number of tokens available.

In some implementations, utilization process 10 determines 104 a token utilization for the workload data based upon, at least in part, the maximum number of KV cache blocks available for the workload data. Token utilization is a measurement of the number of tokens being processed by the AI model using the processing unit (e.g., a GPU) from a number of tokens available. As discussed above, using the maximum number of KV cache blocks available, utilization process 10 is able to determine the number of tokens available. In some implementations, token utilization is a percentage of the number of processing tokens divided by the number of tokens available.

In some implementations, determining 104 the token utilization includes determining 112 a number of processing tokens. A processing token is a token being processed by the AI model using the processing unit. In some implementations, utilization process 10 determines the number of processing tokens by determining: the number of tokens generated for a particular request; the number of context tokens; and the number of tokens cached in the KV cache block(s). A context token is a token used as context for a sample token (i.e., the token being processed). A generated token is a token generated by the AI model in response to the request. Users can specify the maximum token parameter (e.g., max tokens) to determine the largest number of generated tokens desired from the AI model. If stop logic criterion for the AI model is applied before this maximum token limit, then the AI model stops. However, in the example of a GPU, GPU memory is reserved to the full value as specified by the user. As discussed above, to avoid continuously recalculating the same context tokens for each sample token, context tokens are stored in the KV cache. In one example, utilization process 10 determines the number of processing tokens as shown in Equation 1:

$$processing tokens ( t ) = ( context tokens ( t ) - cached tokens ( t ) ) + max\_tokens ( t ) \qquad ( 1 )$$

where t describes each variable in Equation 1 as a function of time.

With the number of processing tokens and the number of tokens available (e.g., which is based on remaining memory available on the GPU after the AI model and system memory are consumed), utilization process 10 determines 104 the token utilization at a particular point in time for the GPU as shown below in Equation 2:

$$token utilization ( t ) = \frac{processing tokens ( t )}{available tokens ( t )} \qquad ( 2 )$$

where t describes each variable in Equation 2 as a function of time.

In some implementations, determining 104 the token utilization includes determining 114 a performance configuration for the workload data based upon, at least in part, the number of tokens available and the number of processing tokens. A performance configuration is a set of parameters of the processing unit (e.g., a number of KV cache blocks allocated to a particular AI model) for specific periods of time based upon latency, requests per second, and/or token processing rate. Referring again to FIG. 3 and in one example, simulation engine 204 generates a graph (e.g., graph 304) based on simulations for requests per second (RPS) over time against model overload messages received over time. As shown in graph 304, utilization process 10 determines the point (e.g., point 306) where model overload messages are first received relative to the RPS value. In some implementations, utilization process 10 defines point 306 as the max RPS value for the workload data before KV cache 222 is saturated.

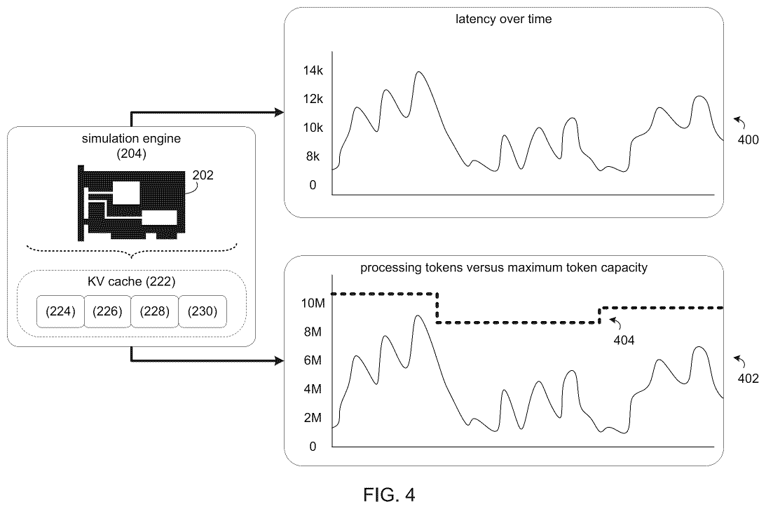

Referring also to FIG. 4 and in some implementations, utilization process 10 generates a graph (e.g., graph 400) simulating latency in the processing of tokens experienced by the AI model over time. In the example of graph 400, the latency is shown as a p50 or median latency measurement over time. In some implementations and as shown in FIG. 4, simulation engine 204 generates a graph (e.g., graph 402) based on simulations for the number of processing tokens versus the maximum number of tokens available/the maximum capacity of tokens available over time for the workload data. In this example, the latency shown in graph 402 generally tracks the number of processing tokens in graph 402. As will be discussed in greater detail below, the variations in the maximum capacity of tokens available shown in the broken line (e.g., broken line 404) represent changes in the allocation of GPU resources for the AI model over time.

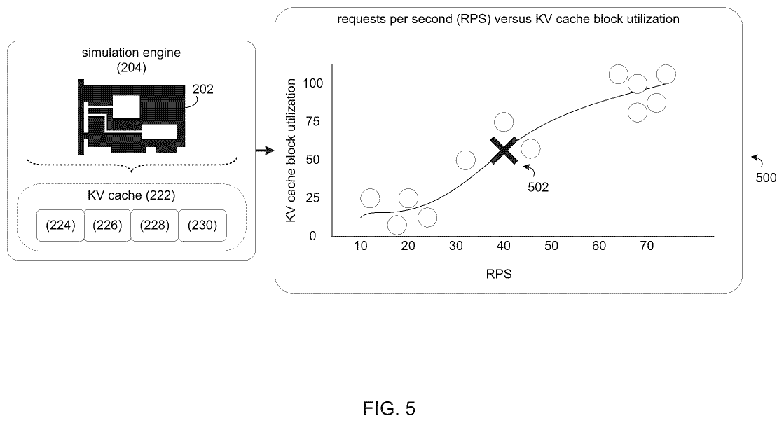

Referring also to FIG. 5, utilization process 10 determines 114 a performance configuration for the workload data based upon, at least in part, the number of tokens available and the number of processing tokens. As shown in graph 500, utilization process 10 simulates the KV cache block utilization relative to the requests per second (RPS) metric. In this example, utilization process 10 determines a performance configuration for the workload data (e.g., performance configuration 502 represented by the “X” in graph 500) as a particular KV cache block utilization rate. Accordingly, utilization process 10 uses the determined KV cache block utilization rate to modify the maximum number of KV cache blocks allocated to processing the workload on the AI model over time.

In some implementations, determining 114 the performance configuration for the workload data includes receiving user-defined or system-defined constraints associated with the GPU and/or the AI model. For example, in addition to determining the number of tokens available for a particular workload over time to determine a performance configuration, utilization process 10 includes an action of receiving constraints or processing requirements to influence the performance configuration. In one example, suppose a user-defined constraint defines a maximum latency value for the AI model (e.g., where the user-defined constraint is provided using a user interface). In another example, suppose a system-defined constraint defines a maximum number of tokens (e.g., based on hardware limitations). In each of these examples, utilization process 10 determines performance configurations to satisfy the constraints and to optimize the performance of the GPU for the AI model using the token utilization. In one example, the performance configuration is a static configuration that is updated or modified over time by utilization process 10. In another example, the performance configuration is a function or model of performance configuration values over time. For example, as opposed to repetitively determining the performance configuration for the workload data, utilization process 10 determines 114 a function or model of performance configuration parameters over time. In this manner, the performance configuration can account for known changes in the workload data associated with the plurality of requests over time.

In some implementations, determining 104 the token utilization includes determining 116 a processing unit memory utilization limit. A processing unit memory utilization limit is a memory resource-based constraint associated with the processing unit. For example, and as discussed above, requests that result in responses with large numbers of tokens require significant amounts of KV cache block space. Accordingly, and in some implementations, the processing memory utilization limit is defined in terms of the number of tokens available as each token requires a certain amount of KV cache block space. In some implementations, the performance configuration for the workload data is based upon, at least in part, the processing unit memory utilization limit. In this manner, the performance configuration accounts for the processing unit memory utilization limitations of the processing unit and AI model for the workload data.

In some implementations, determining 104 the token utilization includes determining 118 a processing unit computing utilization limit. For example, in cases where the AI model is generating a very small number of output tokens but needs to ingest many input tokens, the processing of tokens for the AI model will be limited by processing unit computing requirements. In some implementations, the processing unit computing utilization limit is the maximum throughput of the AI model given the processing unit and the AI model implementation. In the example of a GPU, the GPU computing utilization limit includes a lower-layer bound imposed by GPU FLOPs, memory-bandwidth, and communication bandwidth across different GPUs. For example, utilization process 10 calculates the token throughput per second to define a GPU computing utilization measurement. In some implementations, the performance configuration for the workload data is based upon, at least in part, the GPU computing utilization limit. In this manner, the performance configuration accounts for the processing unit computing utilization limitations of the processing unit and AI model for the workload data.

In some implementations, utilization process 10 allocates 106 processing unit resources for the AI model based upon, at least in part, the token utilization. Allocating 106 processing unit resources includes distributing or assigning a number of, or size of, processing unit memory to an AI model according to the workload data. For example, when an AI model is deployed on one or more GPUs, utilization process 10 processes 100 workload data associated with a plurality of requests for an AI model and determines 102 a maximum number of KV cache blocks for the workload data by simulating the workload data using a simulation engine. Token utilization is determined 104 for the workload data using the maximum number of KV cache blocks. In some implementations, allocating 106 processing unit resources includes assigning an amount of memory (e.g., in terms of storage space) and/or an amount of computing resources (e.g., in terms of cores or other processing units) to the AI model deployed on the processing unit using the token utilization. With the token utilization for the workload data, utilization process 10 is able to dynamically and intelligently allocate 106 GPU resources in a manner that accounts for the types of GPU utilization limits (e.g., GPU memory limitations or GPU computing limitations), user-defined or system-defined constraints, and temporal fluctuations in the workload data.

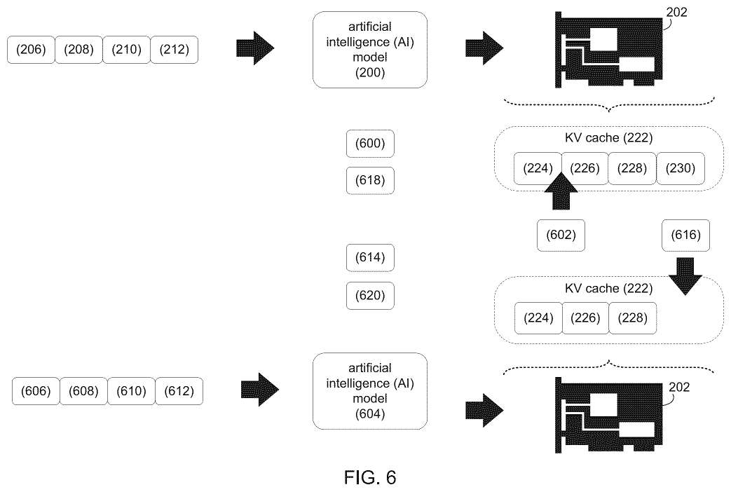

Referring also to FIG. 6 and in some implementations, suppose an AI model (e.g., AI model 200) is processing a plurality of requests (e.g., requests 206, 208, 210, 212) on a processing unit (e.g., GPU 202). Suppose utilization process 10 determines 104 the token utilization (e.g., token utilization 600) for the workload data for requests 206, 208, 210, 212. In this example, suppose utilization process 10 determines that during a particular period of time (e.g., between the hours of 9 AM EST and 5 PM EST during the work week), the workload data associated with requests 206, 208, 210, 212 indicates detailed requests with smaller responses (e.g., requests to generate code segments that perform a number of particular functions). From this workload data, utilization process 10 determines that this workload data will be limited by GPU computing limitations. Accordingly, token utilization 600 indicates that GPU computing resources are highly utilized for AI model 200 during the 9 AM to 5 PM EST time window. In this example, utilization process 10 allocates 106 GPU resources (e.g., GPU computing resources) to GPU 202 for processing requests 206, 208, 210, 212 for AI model 200. In the example of FIG. 6, GPU computing resources (e.g., GPU computing resources 602) are allocated to GPU 202 for processing requests 206, 208, 210, 212 for AI model 200.

Continuing with the above example, suppose that AI model 604 is processing a plurality of requests (e.g., requests 606, 608, 610, 612) on a GPU (e.g., GPU 202). Suppose utilization process 10 determines 104 the token utilization (e.g., token utilization 614) for the workload data for requests 606, 608, 610, 612. In this example, suppose utilization process 10 determines that during a particular period of time (e.g., between the hours of 6 PM EST and 1 AM EST during the work week), the workload data associated with requests 606, 608, 610, 612 indicates smaller requests with larger responses (e.g., requests to write essays, provide detailed summaries, research concepts, etc.). From this workload data, utilization process 10 determines that this workload data will be limited by GPU memory limitations. Accordingly, token utilization 614 indicates that GPU memory resources are highly utilized for AI model 604 during the 9 PM to 1 AM EST time window. In this example, utilization process 10 allocates 106 GPU resources (e.g., GPU memory resources) to GPU 202 for processing requests 606, 608, 610, 612 for AI model 604. In the example of FIG. 6, GPU memory resources (e.g., KV cache block 616) are allocated to KV cache 222 of GPU 202 for processing requests 606, 608, 610, 612 for AI model 604.

In some implementations, allocating 106 the GPU resources for the AI model includes allocating 120 GPU resources for the AI model using the performance configuration. For example, in addition to using token utilizations 606, 614 for allocating 106 GPU resources, utilization process 10 determines and uses performance configuration 618 for the workload data of requests 206, 208, 210, 212 and performance configuration 620 for the workload data of requests 606, 608, 610, 612 to allocate 120 GPU resources for AI models 200, 604. In some implementations, utilization process 10 manages workload demand and GPU capacity using token utilization metrics (e.g., token utilizations 600, 614) and the performance configuration (e.g., performance configurations 618, 620).

In some implementations, utilization process 10 implements the performance configuration with an AI model deployed on a processing unit (e.g., a GPU) to dynamically adjust the token utilization for the workload over time. For example, as new AI models are developed and/or as fine-tuning of these AI models occurs, utilization process 10 determines token utilization for the associated KV cache blocks of the AI models and identifies any change in or optimization of the AI models to more efficiently and dynamically allocate processing unit (e.g., GPU) resources for various workloads.

### System Overview:

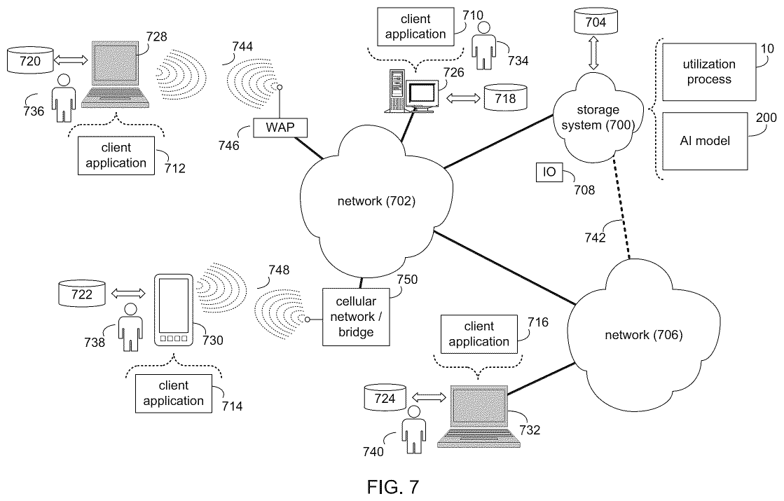

Referring to FIG. 7, a utilization process 10 is shown to reside on and is executed by storage system 700, which is connected to network 702 (e.g., the Internet or a local area network). Examples of storage system 700 include: a Network Attached Storage (NAS) system, a Storage Area Network (SAN), a personal computer with a memory system, a server computer with a memory system, and a cloud-based device with a memory system. A SAN includes one or more of a personal computer, a server computer, a series of server computers, a minicomputer, a mainframe computer, a RAID device, and a NAS system.

The various components of storage system 700 execute one or more operating systems, examples of which include: Microsoft® Windows®; Mac® OS X®; Red Hat® Linux®, Windows® Mobile, Chrome OS, Blackberry OS, Fire OS, or a custom operating system (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

The instruction sets and subroutines of utilization process 10, which are stored on storage device 704 included within storage system 700, are executed by one or more processors (not shown) and one or more memory architectures (not shown) included within storage system 700. Storage device 704 may include: a hard disk drive; an optical drive; a RAID device; a random-access memory (RAM); a read-only memory (ROM); and all forms of flash memory storage devices. Additionally or alternatively, some portions of the instruction sets and subroutines of utilization process 10 are stored on storage devices (and/or executed by processors and memory architectures) that are external to storage system 700.

In some implementations, network 702 is connected to one or more secondary networks (e.g., network 706), examples of which include: a local area network; a wide area network; or an intranet.

Various input/output (IO) requests (e.g., IO request 708) are sent from client applications 710, 712, 714, 716 to storage system 700. Examples of IO request 708 include data write requests (e.g., a request that content be written to storage system 700) and data read requests (e.g., a request that content be read from storage system 700).

The instruction sets and subroutines of client applications 710, 712, 714, 716, which may be stored on storage devices 718, 720, 722, 724 (respectively) coupled to client electronic devices 726, 728, 730, 732 (respectively), may be executed by one or more processors (not shown) and one or more memory architectures (not shown) incorporated into client electronic devices 726, 728, 730, 732 (respectively). Storage devices 718, 720, 722, 724 may include: hard disk drives; tape drives; optical drives; RAID devices; random access memories (RAM); read-only memories (ROM), and all forms of flash memory storage devices. Examples of client electronic devices 726, 728, 730, 732 include personal computer 726, laptop computer 728, smartphone 730, laptop computer 732, a server (not shown), a data-enabled, and a dedicated network device (not shown). Client electronic devices 726, 728, 730, 732 each execute an operating system.

Users 734, 736, 738, 740 may access storage system 700 directly through network 702 or through secondary network 706. Further, storage system 700 may be connected to network 702 through secondary network 706, as illustrated with link line 742.

The various client electronic devices may be directly or indirectly coupled to network 702 (or network 706). For example, personal computer 726 is shown directly coupled to network 702 via a hardwired network connection. Further, laptop computer 732 is shown directly coupled to network 706 via a hardwired network connection. Laptop computer 728 is shown wirelessly coupled to network 702 via wireless communication channel 744 established between laptop computer 728 and wireless access point (e.g., WAP) 746, which is shown directly coupled to network 702. WAP 746 may be, for example, an IEEE 802.11a, 802.11b, 802.11g, 802.11n, Wi-Fi®, and/or Bluetooth® device that is capable of establishing a wireless communication channel 744 between laptop computer 728 and WAP 746. Smartphone 730 is shown wirelessly coupled to network 702 via wireless communication channel 748 established between smartphone 730 and cellular network/bridge 750, which is shown directly coupled to network 702.

### GENERAL

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be used. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object-oriented programming language. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet.

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general-purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, not at all, or in any combination with any other flowcharts depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A computer-implemented method, executed on a computing device, comprising:
processing workload data associated with processing a plurality of requests for an artificial intelligence (AI) model on a processing unit;
determining a maximum number of key-value (KV) cache blocks available for the workload data by simulating the workload data using a simulation engine;
determining a token utilization for the workload data based upon, at least in part, the maximum number of KV cache blocks available for the workload data; and
allocating processing unit resources for the AI model based upon, at least in part, the token utilization.

2. The computer-implemented method of claim 1, wherein processing the workload data includes mirroring a plurality of requests received for processing by the AI model on the processing unit to the simulation engine.

3. The computer-implemented method of claim 1, wherein determining the token utilization includes determining a processing unit memory utilization limit.

4. The computer-implemented method of claim 1, wherein determining the token utilization includes determining a processing unit computing utilization limit.

5. The computer-implemented method of claim 1, wherein determining the maximum number of KV cache blocks available for the workload data includes converting the maximum number of KV cache blocks available into a number of tokens available.

6. The computer-implemented method of claim 5, wherein determining the token utilization includes determining a number of processing tokens.

7. The computer-implemented method of claim 6, wherein determining the token utilization includes determining a performance configuration for the workload data based upon, at least in part, the number of tokens available and the number of processing tokens.

8. The computer-implemented method of claim 7, wherein allocating the processing unit resources for the AI model includes allocating processing unit resources for the AI model using the performance configuration.

9. A computing system comprising:
a memory; and
a processor configured to process workload data associated with processing a plurality of requests for an artificial intelligence (AI) model on a graphics processing unit (GPU) by mirroring a plurality of requests received for processing by the AI model on the GPU to a simulation engine, to determine a maximum number of key-value (KV) cache blocks available for the workload data by simulating the workload data using the simulation engine, to determine a token utilization for the workload data based upon, at least in part, the maximum number of KV cache blocks available for the workload data, and to allocate GPU resources for the AI model based upon, at least in part, the token utilization.

10. The computing system of claim 9, wherein determining the token utilization includes determining a GPU memory utilization limit.

11. The computing system of claim 9, wherein determining the token utilization includes determining a GPU computing utilization limit.

12. The computing system of claim 9, wherein determining the maximum number of KV cache blocks available for the workload data includes converting the maximum number of KV cache blocks available into a number of tokens available.

13. The computing system of claim 12, wherein determining the token utilization includes determining a number of processing tokens.

14. The computing system of claim 13, wherein determining the token utilization includes determining a performance configuration for the workload data based upon, at least in part, the number of tokens available and the number of processing tokens.

15. A computer program product residing on a non-transitory computer readable medium having a plurality of instructions stored thereon which, when executed by a processor, cause the processor to perform operations comprising:
processing workload data associated with processing a plurality of requests for an artificial intelligence (AI) model on a graphics processing unit (GPU);
determining a maximum number of key-value (KV) cache blocks available for the workload data by simulating the workload data using a simulation engine;
converting the maximum number of KV cache blocks available into a maximum number of tokens available;
determining a token utilization for the workload data based upon, at least in part, the number of tokens available; and
allocating GPU resources for the AI model based upon, at least in part, the token utilization.

16. The computer program product of claim 15, wherein processing the workload data includes mirroring a plurality of requests received for processing by the AI model on the GPU.

17. The computer program product of claim 15, wherein determining the token utilization includes determining a GPU memory utilization limit.

18. The computer program product of claim 15, wherein determining the token utilization includes determining a GPU computing utilization limit.

19. The computer program product of claim 15, wherein determining the token utilization includes determining a number of processing tokens.

20. The computer program product of claim 19, wherein determining the token utilization includes determining a performance configuration for the workload data based upon, at least in part, the number of tokens available and the number of processing tokens.
